(19) United States
(12) Patent Application Publication
(10) Pub. No.: US 2025/0290821 A1
(43) Pub. Date: Sep. 18, 2025

(54) TOOL, SYSTEM AND METHOD FOR APPLYING PRESSURE THROUGH A CYLINDRICAL UNTHREADED ORIFICE

(71) Applicant: The United States of America, as Represented by the Secretary of the Navy, San Diego, CA (US)

(72) Inventors: Craig Martin Smith, El Cajon, CA (US); Leif Erik Roth, Chula Vista, CA (US)

(73) Assignee: The United States of America, as Represented by the Secretary of the Navy, Arlington, VA (US)

(21) Appl. No.: 18/606,356

(22) Filed: Mar. 15, 2024

(51) Int. Cl. G01M 3/28

(52) U.S. Cl. CPC G01M 3/2815; G01M 3/2884

(57) ABSTRACT

The present invention includes embodiments of a tool, system, and method for applying pressure through a cylindrical unthreaded orifice. The tool may include a hollow tool body with a distal portion for insertion within the cylindrical unthreaded orifice and having an O-ring to achieve a seal against the cylindrical unthreaded orifice. The tool may further include a wedge sleeve, nut and washer used in conjunction with a threaded portion on the tool body to secure the tool within the cylindrical unthreaded orifice during use.

### FEDERALLY SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, CA, 92152; voice: (619) 553-5118; email: NIWC_Pacific_T2@navy.mil. Reference Navy Case Number 210876.

### BACKGROUND OF THE INVENTION

### Field of the Invention

The present invention relates generally to systems and methods for pressure testing. More particularly, the present invention relates to systems and methods for introducing a pressurized fluid via a smooth cylindrical orifice.

### Description of Related Art

There are many structures that are designed to contain or withstand pressure, including pumps, tanks for storing pressurized air or liquids, pipes, and the like. To confirm that such a pressure system, or pressurizable structure, will perform as designed, may require pressure testing. Pressure tests are generally performed to ensure the safety, reliability, and leak tightness of pressure systems. A pressure test may be required for a new pressure system before use or an existing pressure system after repair or alteration.

There are generally two methods for pressure tests: hydrostatic and pneumatic. A hydrostatic test, as the name suggests, is performed using water as the test medium, although other fluids might be employed depending on the application and system being tested. In contrast a pneumatic test generally uses air, nitrogen, or any non-flammable and non-toxic gas. Pressure testing generally requires the use of a properly calibrated gauge sized such that the test pressure is in the middle third of the gauge's pressure range. Generally, pressure tests are performed under controlled conditions, following a test plan, and documented in a test record.

There are various tools and fixtures used to test pressure systems including, e.g., a source of the pressure medium (e.g., air, water, oil, etc.), a safety manifold or valve(s) for introducing the medium source to the system under test, a pressure gauge for measuring the pressure in the system, additional valves for isolation, pressure relief and venting, and mechanical interfaces between each of the components used to pressure test the pressure system. It will be understood that leak-proof mechanical interfaces are required to properly pressure test the system under test. Such mechanical interfaces may be threaded, include seals, or both to form a leak-proof interface between system test components.

Without a dedicated mechanical interface it may be difficult to introduce a pressurized medium (fluid or gas) into a system for pressure testing. For example, without mechanical interface fixturing, it may be quite difficult to pressure test a system through a cylindrical orifice that has no threading and just a smooth cylindrical surface on the inside.

In view of the foregoing and for other reasons that will become more evident with the disclosure herein, there exists a need in the art for tools, systems, and methods for applying pressure via a smooth cylindrical unthreaded orifice.

### SUMMARY OF THE INVENTION

An embodiment of a tool for applying pressure through a cylindrical unthreaded orifice to a system under test is disclosed. The embodiment of a tool may include a tool body including a proximal end separated from a distal end along a tool axis and a passage extending axially from the proximal end to the distal end for delivering a pressurized fluid from a source through the cylindrical unthreaded orifice to the system under test. The embodiment of a tool body may further include a distal portion extending from the distal end towards the proximal end, the distal portion comprising an external diameter, D₁, the distal end configured to slide within the cylindrical unthreaded orifice. The embodiment of a tool body may further include a tapered portion extending from the distal portion towards the proximal end and having variable external diameter decreasing from D₁ to D₂. The embodiment of a tool body may further include an intermediate portion extending from the tapered portion along the tool axis towards the proximal end having external diameter, D₂. The embodiment of a tool body may further include a threaded portion having external threading and extending from the intermediate portion along the tool axis towards the proximal end having an external diameter, D₃, where D₁>D₃>D₂. The embodiment of a tool body may further include a proximal portion extending from the threaded portion along the tool axis to the proximal end. The embodiment of a tool may further include a wedge sleeve having a hollow cylindrical shape with an external diameter, D₁, and an internal diameter greater than D₃, and configured to slide over the threaded portion. The embodiment of a tool may further include a washer having an internal diameter also greater than D₃, but less than D1. The embodiment of a tool may further include a nut configured with internal threading mating with the external threading of the threaded portion.

An embodiment of a hollow tool body having a tool axis is disclosed. The embodiment of a tool body may be used to apply pressure through a cylindrical unthreaded orifice. The embodiment of a tool body may further include a distal portion having external diameter, D₁, extending axially from a distal end toward a proximal end and configured to slide within the cylindrical unthreaded orifice. The embodiment of a tool body may further include a tapered portion having variable diameter ranging between D₁, and D₂, extending axially from the distal portion. The embodiment of a tool body may further include an intermediate portion having external diameter, D₂, extending axially from the tapered portion. The embodiment of a tool body may further include a threaded portion having external threading with external diameter, D₃, where D₁>D₃>D₂, and extending axially from the intermediate portion. The embodiment of a tool body may further include a proximal portion having external diameter, D₄, where D₂>D₄, and extending from the threaded portion to a proximal end.

An embodiment of a method of pressure testing a system under test through a cylindrical unthreaded orifice is disclosed. The embodiment of a method may include providing a system for applying pressure through the cylindrical unthreaded orifice. According to this particular method embodiment, the system may include a hollow tool having a distal portion configured for insertion and interference fit within the cylindrical unthreaded orifice. According to this particular method embodiment, the system may further include a hose with a first end configured to attachment to a proximal portion of the tool. According to this particular method embodiment, the system may further include a pressure source. According to this particular method embodiment, the system may further include a pressure regulator interfacing between a second end of the hose and the pressure source. The embodiment of a method may further include inserting the distal portion of the tool within the cylindrical unthreaded orifice to form a seal. The embodiment of a method may further include tightening the tool within the cylindrical unthreaded orifice. The embodiment of a method may further include applying a preselected pressure using the pressure source through the tool and through the cylindrical unthreaded orifice to the system under test.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is an exploded side view of an exemplary tool for applying pressure through a cylindrical unthreaded orifice, according to the present invention.

FIGS. 2A and 2B are top and side views, respectively, of the exemplary tool body shown in FIG. 1 without O-ring installed, according to the present invention.

FIG. 3 is a cross-sectional view of a procedure for installation of the embodiment of a tool within a cylindrical unthreaded orifice, according to the present invention.

FIG. 4 is a cross-sectional view of the embodiment of a tool installed within a cylindrical unthreaded orifice and under pressure, according to the present invention.

FIG. 5 is an image of a system for applying pressure through an unthreaded orifice, according to the present invention.

FIG. 6 is an enlarged image of an embodiment of a tool as shown in FIGS. 1 and 5, assembled with hose attached, according to the present invention.

FIG. 7 is a block diagram of an embodiment of another system for applying pressure through a cylindrical unthreaded orifice, according to the present invention.

FIG. 8 is a flowchart of an embodiment of a method for applying pressure through a cylindrical unthreaded orifice, according to the present invention.

FIG. 9 is an exploded perspective view of another embodiment of a tool for applying pressure through a cylindrical unthreaded orifice, according to the present invention.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment but may be expanded for use with any of the other methods and systems described herein as will be understood by one of ordinary skill in the art unless specifically otherwise stated.

The genesis of this invention was the need to pressure test a mechanism that is pressure and time activated. The mechanism relies on a pressure transducer and internal clock to determine when to activate. The transducer is tucked inside the system under test and cannot be accessed directly. Historically, the way the system was tested was by submerging it in a pressure tank, pressurizing it and waiting for the activation time to lapse. The system under test would then be pulled from the tank to see if it activated. However, it was difficult to tell if the assembly activated when it was supposed to, or if it activated too early. It could only be said that it had activated. It will be appreciated that this is an expensive and time-consuming process to test these particular mechanisms. Additionally, the pressure tank equipment used to conventionally test such systems are not commonly available and are cumbersome. If the testing orifice had attachment features, fixtures, flanges, ribbing, threaded fitting, or other special machining that allowed a simple connection to a pressure source, the need for a special tool would be obviated. However, in instances where the test port is just a cylindrical unthreaded orifice, that would require adding fixturing to the system under test, which is time consuming to install and use. Additionally, the addition of fixturing features to be machined or otherwise added into the system under test also occupies significant space requiring the whole system under test to be larger.

For these reasons, it was desirable to develop a tool, system, and method of fully pressure testing such pressure transducer mechanisms without submerging in a pressure tank, requiring no additional features to be machined and that was easy to use. The inventive tool, system and method disclosed herein were developed to solve these technical problems. Using the inventive tool, system and methods disclosed herein, the system under test can be tested easily and quickly on a benchtop in the lab, allowing the user to observe exactly when the activation occurred.

Although the genesis for this invention was to solve the problem of testing particular pressure transducers in a particular system under test, the inventors appreciated that the invention could be used in many other contexts and scaled for various applications. For example, and not by way of limitation, embodiments of the inventive tool may be used to pressurize any system with a smooth orifice capable of sealing. More particularly, a good use of the tool is pressurizing welded pipe assemblies with many welded seams, intermittently during fabrication before flanges or threaded fittings can be installed. Finding leaks, before a complex pipe assembly has been completed will be very useful. Embodiments of the invention disclosed herein provides a suitable method of purging pipe weldments with inert gases during welding. Additionally, with regard to pipe welding, this tool could be easily reinstalled in each new section of pipe since it fixes to the inside of the pipe and does not require a flange or anything to mount to.

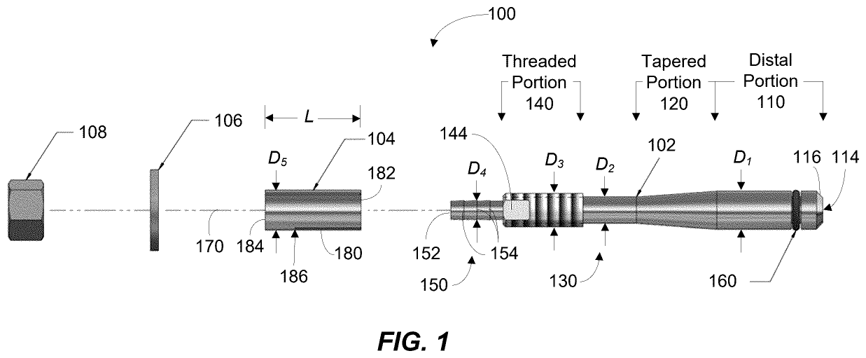

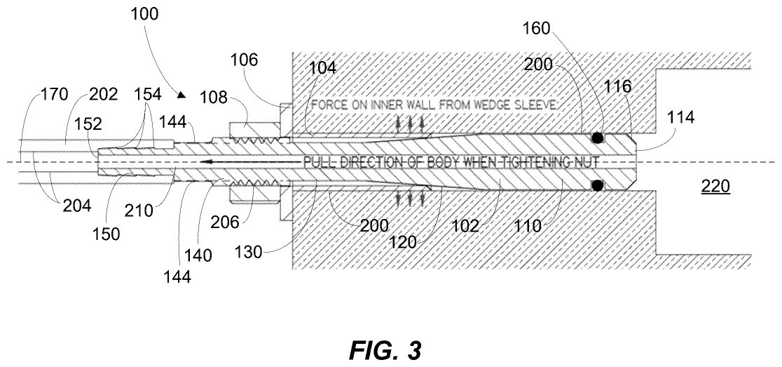

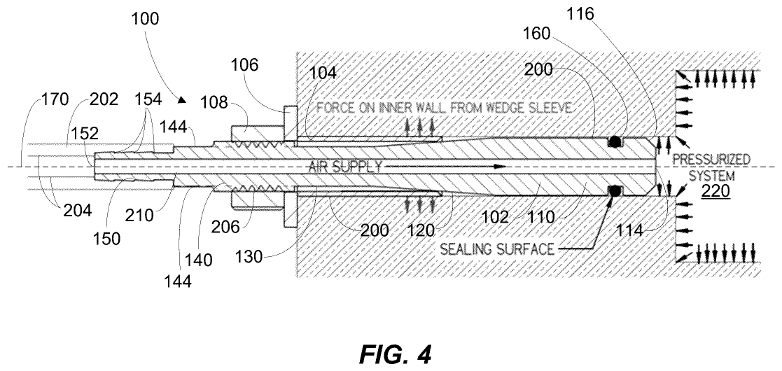

FIG. 1 is an exploded side view of an exemplary tool 100 for applying pressure to a cylindrical unthreaded orifice, according to the present invention. From right to left in FIG. 1, the embodiment of a tool 100 may include a tool body 102 with O-ring 160, wedge sleeve 104, washer 106 and nut 108. The components 102, 104, 106, 108 and 160 of tool 100 are configured for coaxial assembly along tool axis 170. Though not shown in FIG. 1, the tool body 102 includes a fluid passage (see FIGS. 3 and 4 and passage 210) extending axially 170 from proximal end 152 to distal end 114.

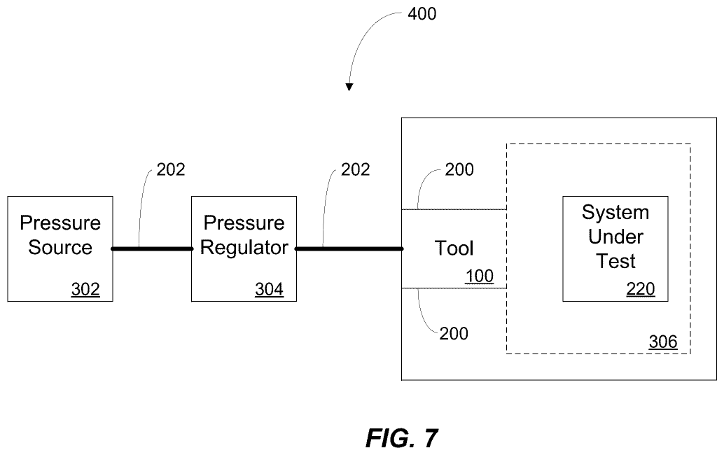

As shown in FIG. 1, an embodiment of a tool body, shown generally at arrow 102, may include a distal portion 110 with a distal end 114 configured for insertion within a cylindrical unthreaded orifice 200 (not shown but see FIGS. 3-4 and 7 and related discussion herein). The embodiment of a tool body 102 may further include and a proximal portion, shown generally at arrow 150, with a proximal end 152. The proximal portion 150 may be configured to interface with a high-pressure fluid source 302 (also not shown in FIG. 1 but see FIG. 7). Though not visible in FIG. 1, the tool body 102 includes a passage extending axially 170 from the proximal end 152 to the distal end 114 for delivering a high-pressure fluid from the proximal end 152 to the distal end 114. The embodiment of a tool body 102 may further include a threaded portion 140 disposed between the proximal end 152 and the distal end 114.

Still more particularly, the distal portion 110 is configured with an external diameter, D₁, which is sized to slide within the cylindrical unthreaded orifice 200 (not shown in FIG. 1 but see cylindrical unthreaded orifice 200 in FIGS. 3-4 and 7) and seal via O-ring 160. The embodiment of a tool body 102 may further include a tapered portion 120 extending axially 170 with variable diameter down to an intermediate portion, shown generally at arrow 130, with external diameter, D₂. The embodiment of a tool body 102 may further include a threaded portion 140 extending between the proximal portion 150 and the intermediate portion 130. Though not required, distal end 114 may rounded 116, smoothed, or otherwise shaped to ease insertion within any given cylindrical unthreaded orifice.

The threaded portion 140 of tool body 102 may have an external diameter, D₃, with external threading 142 configured to mate with internal threading (not visible in FIG. 1, but inherent) disposed within nut 108. Although D₃ is illustrated as being greater than D₂, there is no requirement that D₃>D₂. Threaded portion 140 may further include two opposed flats 144 (only one flat 144 visible in FIG. 1) for interfacing with a wrench (not shown) during assembly. It will be understood that any suitable wrenches, for example and not by way of limitation, a crescent wrench, spanner, open-ended wrench, etc., may be used with the flats 144 and nut 108 in order to hold the tool body 102 from rotating as nut 108 is tightened along mated threading 142 on the threaded portion 140.

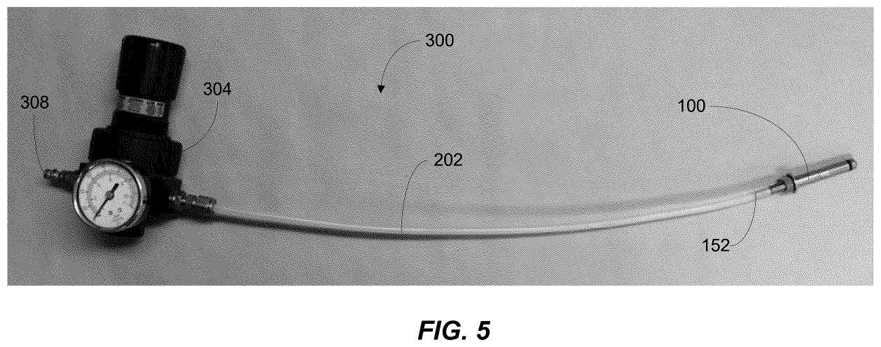

The proximal portion 150 of tool body 102 may have an external diameter, D₄, and a series of machined barbs 154 for internally gripping a hose (not shown in FIG. 1 but see, e.g., hose 202 in FIGS. 3-7) thereby forming a pressure-tight seal between the hose 202 and the proximal portion 150. According to alternative embodiments, proximal portion may have smooth, textured, or ribbed external surface and configured to form an air-tight seal using a hose clamp or other mechanical mechanism to hold the hose 202 in place on the proximal portion 150. The hose 202 may in turn be connected to the high-pressure fluid source (not shown in FIG. 1, but see, e.g., pressure source 302 in FIG. 7) via an intermediate pressure regulator (also not shown in FIG. 1 but see, e.g., pressure regulator 304 in FIGS. 5 and 7).

As shown in FIG. 1, the exemplary tool 100 may further include a wedge sleeve 104. Wedge sleeve 104 may be generally tubular in shape with an outside diameter, D₅, (where D₅, is approximately equal to D₁) which (like distal portion 110) is also sized to slide within the cylindrical unthreaded orifice. Though not visible in FIG. 1, wedge sleeve 104 may further be configured with an internal diameter greater than D₃, so that it can slide over threaded portion 140 and abut against the tapered portion 120. Overall wedge sleeve 104 length, L, may be selected to cover intermediate portion 130 and be supported at opposite ends by tapered portion 120 and threaded portion 140 during installation within a given cylindrical unthreaded orifice.

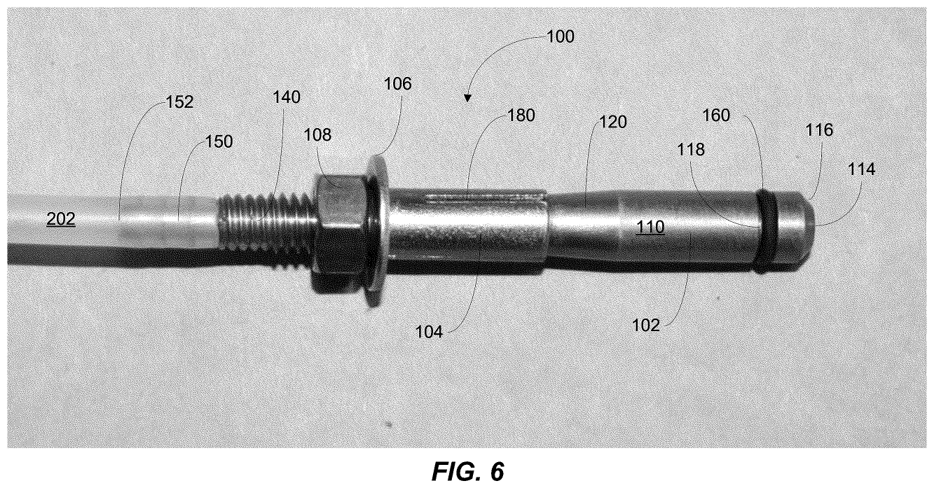

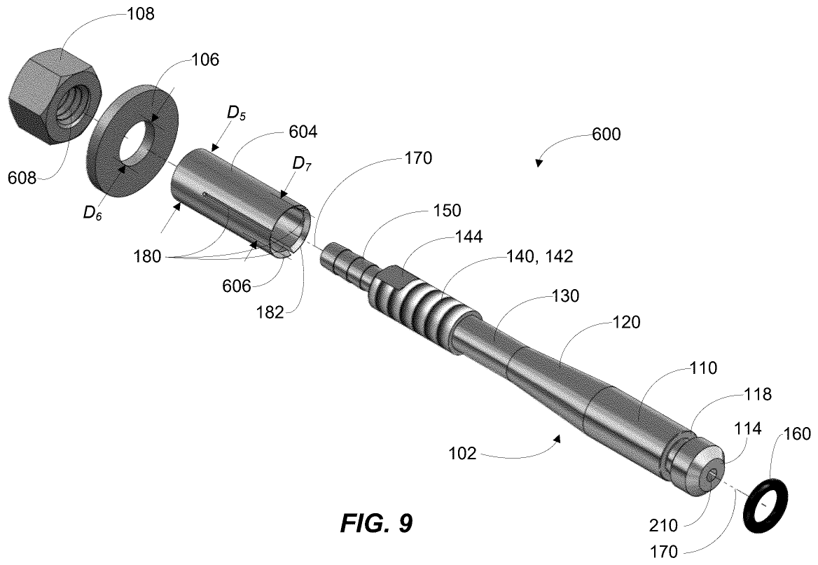

Wedge sleeve 104 may further include one or more slots 180 (see dark line at bottom of wedge sleeve 104 in FIG. 1) disposed along a portion of the length of the wedge sleeve 104 that allows the wedge sleeve 104 to deform under compression as explained in greater detail below. More particularly, the at least one slot 180 extends from wedge sleeve distal end 182 in the direction of wedge sleeve proximal end 184 to a point 186. That is to say, point 186 lies in between distal 182 and proximal 184 ends of wedge sleeve 104. See also FIGS. 6 and 9 for a better illustration of the at least one slot 180 and related discussion below.

Referring again to FIG. 1, the exemplary tool 100 may further include washer 106 with an internal diameter identical to the internal diameter of wedge sleeve 104 allowing it to pass over the proximal portion 150, threaded portion 140 and intermediate portion 130 of the tool body 102. Washer 106 is configured to abut against wedge sleeve proximal end 184 and is used to push wedge sleeve 104 against tapered portion 120 under axial force directed in the distal direction along axis 170 during nut 108 tightening.

In summary, embodiments of tool body 102 generally include the following five features. First, the proximal portion of the tool body 102 may include barbs 154 to allow the installation of tubing or hose 202 directly to the tool 100. With this feature, there are no additional fittings required to attach to a pressure tube or hose 202. Second, the threaded portion 140 may be configured to receive a nut 108 with matching threads. Third, two flats 144 may be disposed into the threaded portion 140 to allow for a wrench to be used to keep the tool 102 and tool body 102 from rotating when tightening the nut 108. Fourth, the tool body 102 may be formed with a tapered portion 120 which spreads the wedge sleeve 104 radially outward when tightening the nut 108 and thus anchoring the tool 100 to the inside wall of the cylindrical unthreaded orifice 200. Fifth, an O-ring groove 118 may be formed in the distal portion 110 of tool body 102 for receiving a sealing O-ring 160.

It will be understood that any suitable custom-made or commercial off-the-shelf (COTS) components may be used to fabricate tool 100. According to one particular embodiment of tool 100, O-ring 160 may be a 1/16 fractional width, dash number 010, having part number 9452K18 and material BUNA-N, 70A, available from McMaster-Carr Supply Company. According to another particular embodiment of tool 100, washer 106 may be a passivated, 5/16″ screw size, having part number 92503A120, formed of material 18-8 SST, available from McMaster-Carr Supply Company. According to yet another particular embodiment of tool 100, nut 108 may be hex nut, 1/16″, 18 thread size, having part number 92673A119, formed of material 18-8 SST, available from McMaster-Carr Supply Company. Wedge sleeve 104 and tool body 102 may be formed of any suitable metal. According to a particular embodiment, wedge sleeve 104 and tool body 102 may both be formed of brass for ease of machining and because it is a softer metal, it reduces the likelihood of scoring the inside surface of the unthreaded cylindrical orifice within which they are installed during use. However, it will be understood that other similar metals or metal alloys, such as bronze and copper may be used consistent with the teachings of the present invention.

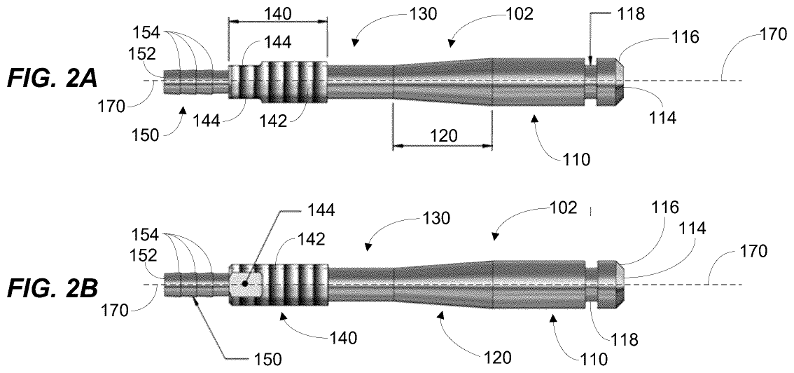

FIGS. 2A and 2B are top and side views, respectively, of the exemplary tool body 102 shown in FIG. 1 without O-ring 160 installed, according to the present invention. FIGS. 2A and 2B best illustrate opposed flats 144 (both shown in FIG. 2A, one shown in FIG. 2B). FIGS. 2A and 2B also illustrate barbs 154 disposed about the outer surface of proximal portion 150. The barbs 154 are formed at interfacing edges of multiple serially and coaxial frustoconical segments running circumferentially about the outer surface of proximal portion 150. FIGS. 2A and 2B also best illustrate the O-ring groove 118, which is configured to receive O-ring 160 (not shown). FIGS. 2A and 2B also illustrate frustoconical tapering 116 of distal end 114. As noted herein, tapering 116 eases the installation of the distal end 110 within a cylindrical unthreaded orifice (not shown).

FIG. 3 is a cross-sectional view of a procedure for installation of the embodiment of a tool within a cylindrical unthreaded orifice, according to the present invention. More particularly, FIG. 4 illustrates hose 202 connected to proximal portion 150 with the inner surface 204 of one end of hose 202 pushed to threaded portion 140 and gripped by barbs 154. According to various embodiments, hose 202 may be ⅛″, or any other internal diameter, plastic, vinyl, or polyvinyl chloride (PVC) tubing. Generally, hose 202 should be an elastically deformable tube capable of forming an air-tight seal when placed around the proximal portion 150. FIG. 3 illustrates both flats 144 shown opposite each other on threaded portion 140 and adjacent to proximal portion 150. FIG. 3 further illustrates wedge sleeve 104 pushed within cylindrical unthreaded orifice 200 via washer 106 and nut 108 by application of axial movement toward the distal end 114 using two wrenches (not shown, one on the flats 144 and one on nut 108. The tightening of nut 108 pulls the tool body 102 axially to the left and compresses the wedge sleeve 104 against the cylindrical unthreaded orifice 200.

During operation, the tool 100 may be inserted into the orifice 200. Once inserted, the tool body 102 may be held to prevent rotating with a wrench while the nut 108 is tightened. As the nut 108 is tightened, the tool body 102 of the tool 100 starts to pull out (move axially in the proximal direction, to the left in FIG. 3) of the orifice 200, but the wedge sleeve 104 is held firm in the orifice 200 by the washer 106. The wedge sleeve 104 is forced radially outward onto the orifice wall by the tapered portion 120 of the tool body 102. This wedging action provides a high frictional force between the wedge sleeve 104 and the orifice inner wall, thus holding the tool 100 within the orifice 200.

FIG. 4 is a cross-sectional view of the embodiment of a tool 100 installed within a cylindrical unthreaded orifice 200 under pressure, according to the present invention. More particularly, FIG. 4 illustrates hose 202 connected to proximal portion 150 with the inner surface 204 of one end of hose 202 pushed to threaded portion 140 and gripped by barbs 154. Though not shown in FIG. 4, the other end of hose 202 may be attached directly to a pressure source or with intervening valving and pressure regulators, see, e.g., FIGS. 5 and 7. FIG. 4 (like FIG. 2A) illustrates both flats 144 shown opposite each other about the tool axis 170 on the threaded portion 140 and adjacent to proximal portion 150. As shown in FIG. 4, wedge sleeve 104 has been pushed within cylindrical unthreaded orifice 200 via washer 106 with axial movement toward the distal end 114 provided by nut 108 and matched threads 206 from the nut 108 and threaded portion 140. Once the wedge sleeve 104 is firmly in place, a pressure can be applied to the system under test 220 without the tool 100 backing out, see FIG. 4. In fact, the pressure acts on the body 102 of the tool 100 in a direction that wedges the sleeve 104 onto the orifice inner wall even further, thus strengthening the anchoring force of the tool 100.

It will be understood that the pressure seal is formed by the O-ring 160 in an interference fit against the cylindrical unthreaded orifice 200 as best shown in FIG. 4. The wedge sleeve 104 is used to secure the tool 100 within the cylindrical unthreaded orifice 200 during use and does not form a pressure seal. During installation of the tool 100 within orifice 200, the nut 108 is tightened axially against the washer 106 and in turn against the wedge sleeve 104. When the nut 108 pushes the wedge sleeve 104 down the tapered portion 120 axially, the wedge sleeve 104 causes the at least one slot 180 to widen and the distal end 182 of wedge sleeve 104 pushes into the wall of the cylindrical unthreaded orifice 200. The component tolerances may be configured such that the slotted distal end 182 of the wedge sleeve 104 expands and contacts the orifice 200 prior to the proximal end 184 of the wedge sleeve 104 engaging with the tapered portion 120. In this way, the slotted distal end 182 of the wedge sleeve 104 engages on the orifice 200 to complete the installation.

As shown in FIG. 4, during use, a pressure source (not shown but connected to the hose 202) supplies a fluid pressure axially 170 through passage 210 to a system under test 220. The fluid may be air and the pressure source may be an air compressor, according to one embodiment. Though simply depicted as a pressure chamber accessible via the cylindrical unthreaded orifice 200 as shown in FIG. 4, the system under test 220 could be any suitable device or structure for which pressure testing is required or desirable and as described herein.

FIG. 5 is an image of a system 300 for applying pressure to an unthreaded orifice, according to the present invention. System 300 may include an embodiment of tool 100 with proximal end connected to hose 202. The opposite end of hose 202 may be connected to a pressure regulator for measuring and controlling pressure delivered through the hose 202 and tool 100. Though not shown, it will be understood that the source end 308 of the pressure regulator 304 may be connected to a pressure source (not shown) using another hose 202.

FIG. 6 is an enlarged image of an embodiment of a tool 100 as shown in FIGS. 1 and 5, assembled with hose 202 attached to proximal end 152, according to the present invention. More particularly, FIG. 6 illustrates the tool body 102 with distal portion 110 adjacent to tapered portion 120, threaded portion 140 adjacent to proximal portion 150 and its proximal end 152. FIG. 6 further illustrates hose 202 installed over proximal portion 150, nut 108 threaded onto threaded portion 140 adjacent to waster 106 and wedge sleeve 104. Note that the intermediate portion 130 of tool body 102 is not visible in FIG. 6 because it is covered by wedge sleeve 104. FIG. 6 also shows slot 108 formed within wedge sleeve 104 which allows the wedge sleeve 104 to deform and hold the tool within a cylindrical unthreaded orifice (not shown), when the nut is tightened and wedge sleeve 104 expands while traversing tapered portion 120 in a distal direction. FIG. 6 further illustrates O-ring 160 installed within O-ring groove 118. Finally, FIG. 6 further illustrates frustoconical tapering of the distal end 114 of the distal portion 110 of tool body 102.

FIG. 7 is a block diagram of an embodiment of another system 400 for applying pressure to a cylindrical unthreaded orifice 200, according to the present invention. As depicted in FIG. 7, an embodiment of tool 100 may be inserted within the cylindrical unthreaded orifice 200 and sealed as described with reference to FIGS. 3 and 4 herein. According to the embodiment of system 400 shown in FIG. 7, hose 202 may be attached between a pressure regulator 304 and the proximal end of tool 100. According to the embodiment of system 400 shown in FIG. 7, another hose 202 may be attached between a pressure source 302 and pressure regulator 304. Once the tool 100 is installed and hoses 202 are installed as shown, the pressure source 302 and pressure regulator 304 may be used to apply a selected pressure to the system under test 220 as controlled by the user or suitable system automation. Again, it will be understood that the system under test 220 may be a device within a chamber 306 (dashed line box) pressurized through the cylindrical unthreaded orifice 200. Alternatively, the chamber 306 itself may be the system under test 220, e.g., a pipe being pressure tested. It will be understood that the inventive tool 100 is not limited by the particular system under test 220.

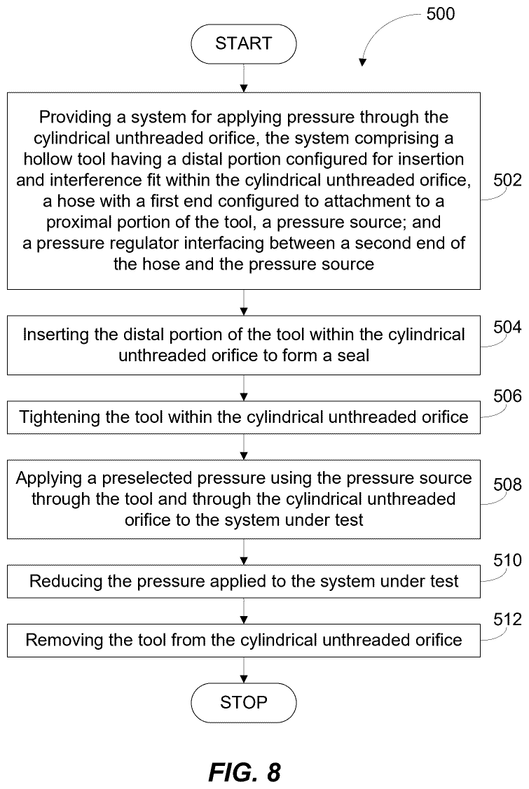

FIG. 8 is a flowchart of an embodiment of a method 500 for applying pressure through a cylindrical unthreaded orifice or pressure testing, according to the present invention. The embodiment of method 500 may include providing 502 a system for applying pressure through the cylindrical unthreaded orifice. It will be understood that the system provided in method 500 may be system 300 or 400 as disclosed herein. According to a particular embodiment of method 500, the system may include a hollow tool having a distal portion configured for insertion and interference fit within the cylindrical unthreaded orifice. According to this particular embodiment of method 500, the system may further include a hose with a first end configured to attachment to a proximal portion of the tool. According to this particular embodiment of method 500, the system may further include a pressure source. According to this particular embodiment of method 500, the system may further include a pressure regulator interfacing between a second end of the hose and the pressure source.

The embodiment of method 500 may further include inserting 504 the distal portion of the tool within the cylindrical unthreaded orifice to form a seal. According to various embodiments of method 500, the tool inserted 504 may be any one of the embodiments of tool 100 disclosed herein with an O-ring to achieve the seal via an interference fit. The embodiment of method 500 may further include tightening 506 the tool within the cylindrical unthreaded orifice. It will be understood that tightening 506 may be achieved driving the wedge sleeve 104 towards the distal end 114 of tool body 102 and against tapered portion 120 which in turn drives the wedge sleeve into the cylindrical unthreaded orifice 200 and thereby holding the tool 100 in place for pressurizing. The embodiment of method 500 may further include applying 508 a preselected pressure using the pressure source through the tool and through the cylindrical unthreaded orifice to the system under test. Once the pressurizing or pressure testing is completed, the embodiment of method 500 may further include reducing 510 the pressure applied to the system under test. The embodiment of method 500 may further include removing the tool from the cylindrical unthreaded orifice. According to a particular embodiment of method 500, the pressure source may be an air compressor. However, it will be understood that the fluid delivered to the system under test 220 may be oil, water, nitrogen, oxygen or any other type of fluid or gas, depending on the system under test 220.

FIG. 9 is an exploded perspective view of another embodiment of a tool 600 for applying pressure through a cylindrical unthreaded orifice, according to the present invention. The embodiment of tool 600 is similar to that of tool 100 with a few notable exceptions or clarifications. The perspective view shown in FIG. 9 illustrates additional features of tool 600. More particularly wedge sleeve 604 is shown with three slots 180 disposed about distal end 182 and extending toward, but not completely to, proximal end 184 of wedge sleeve 604. Each of the three slots 180 is separated radially from an adjacent slot 180 by 120°. It will be understood that any suitable number (e.g., but not by way of limitation, 1 to 6) of slots 180 may be disposed in wedge sleeve 604 to provide even expansion when pressed against tapered portion 120. Accordingly, the present invention is not limited to a wedge sleeve 604 with three slots 180.

FIG. 9 further illustrates internal edge beveling 606 on the distal end 182 of wedge sleeve 604 which is not a feature of wedge sleeve 104 (FIGS. 1 and 3). The purpose for the internal edge beveling 606 is to prevent wedge sleeve 604 from gouging into tapered portion 120 during installation. FIG. 9 further illustrates internal threading 608 of nut 108 which is inherent but not visible in FIG. 1. FIG. 9 further illustrates the inside diameter, D₆, of the washer 106 which is less than the outside diameter, D₅, of wedge sleeve 604. Finally, FIG. 9 further illustrates passage 210 visible from the distal end 114 of the tool body shown generally at arrow 102. Other features and components of tool 600 remain identical to those of tool 100 and are identically referenced.

Having described particular embodiments of a tool, system, and method for pressure testing through a cylindrical unthreaded orifice, more generalized embodiments of the tool and tool body follow.

An embodiment of a tool for applying pressure through a cylindrical unthreaded orifice to a system under test is disclosed. The embodiment of a tool may include a tool body including a proximal end separated from a distal end along a tool axis. The embodiment of a tool body may further include a passage extending axially from the proximal end to the distal end for delivering a pressurized fluid from a source through the cylindrical unthreaded orifice to the system under test. The embodiment of a tool body may further include a distal portion extending from the distal end towards the proximal end. The distal portion of the tool body may be configured with an external diameter, D₁. The distal end of the tool body may be configured to slide within the cylindrical unthreaded orifice. The embodiment of a tool body may further include a tapered portion extending from the distal portion towards the proximal end and having variable external diameter decreasing from D₁ to D₂. The embodiment of a tool body may further include an intermediate portion extending from the tapered portion along the tool axis towards the proximal end having external diameter, D₂. The embodiment of a tool body may further include a threaded portion having external threading and extending from the intermediate portion along the tool axis towards the proximal end having an external diameter, D₃, where D₁>D₃. The embodiment of a tool body may further include a proximal portion extending from the threaded portion along the tool axis to the proximal end.

The embodiment of a tool may further include a wedge sleeve having a hollow cylindrical shape with an external diameter, D₅, and an internal diameter greater than D₃, and configured to slide over the threaded portion. The embodiment of a wedge sleeve may also be configured to slide within the cylindrical unthreaded orifice. The embodiment of a tool may further include a washer having an internal diameter also greater than D₃, but less than D₁. The embodiment of a tool may further include a nut configured with internal threading mating with the external threading of the threaded portion.

According to another embodiment of the tool, the distal portion of the tool body may further include an O-ring groove disposed about a circumference of the distal portion. According to yet another embodiment, the tool may further include an O-ring configured to set within the O-ring groove and provide a seal and interference fit between the tool and the cylindrical unthreaded orifice. According to still another embodiment, the distal portion of the tool body may further include rounding or tapering of the distal end to ease insertion within the cylindrical unthreaded orifice. According to still yet another embodiment, the threaded portion of the tool body may further include opposed flats disposed adjacent to the proximal portion and parallel to the tool axis. The flats may be configured to receive a wrench to prevent the tool body from rotating during installation of the tool within the cylindrical unthreaded orifice.

According to one embodiment of the tool, the wedge sleeve may further include at least one longitudinal slot extending from a wedge sleeve distal end in a direction toward the proximal end, namely to a point in between the wedge sleeve proximal and distal ends. That is, the slot does not extend completely to the wedge sleeve proximal end. According to another embodiment of the tool, the wedge sleeve may further include internal edge beveling in the wedge sleeve distal end configured to push against the tapered portion without gouging the tapered portion by application of axial force in a distal direction caused by tightening of the nut pushing against the washer and in turn against the wedge sleeve proximal end during installation of the tool within the cylindrical unthreaded orifice.

According to yet another embodiment of the tool, the proximal portion may further include a plurality of circumferential barbs disposed about an outer surface of the proximal portion configured for receiving and gripping an inner surface of a hose leading to a pressure source. According to still yet another embodiment of the tool, the tool body and wedge sleeve may each be formed of a metal such as brass, bronze, copper, or metal alloys thereof.

An embodiment of a system for applying pressure through a cylindrical unthreaded orifice to a system under test is disclosed. The embodiment of the system may include an embodiment of the tool disclosed herein and further including a hose having a first end configured for installation on the proximal portion of the tool body. According to another embodiment, the system may further include a pressure regulator configured for interfacing between a pressure source a second end of the hose. According to a particular embodiment of the system, the pressure source may be an air compressor.

An embodiment of a hollow tool body is disclosed. The embodiment of a tool body may include a tool axis. The embodiment of a tool body may be used to apply pressure through a cylindrical unthreaded orifice. The embodiment of a tool body may further include a distal portion having external diameter, D₁, extending axially from a distal end toward a proximal end and configured to slide within the cylindrical unthreaded orifice. The embodiment of a tool body may further include a tapered portion having variable diameter ranging between D₁, and D₂, extending axially from the distal portion. The embodiment of a tool body may further include an intermediate portion having external diameter, D₂, extending axially from the tapered portion. The embodiment of a tool body may further include a threaded portion having external threading with external diameter, D₃, where D₁>D₃, and extending axially from the intermediate portion. The embodiment of a tool body may further include a proximal portion having external diameter, D₄, where D₃>D₄, and extending from the threaded portion to a proximal end.

According to another embodiment of the tool body, the distal portion may further include an O-ring groove disposed about a circumference of the distal portion. According to still another embodiment, the hollow tool body may further include an O-ring configured to rest within the O-ring groove. According to this particular embodiment, the O-ring provides a seal and interference fit between the hollow tool body and the cylindrical unthreaded orifice. According to yet another embodiment of the tool body, the distal portion may further include rounding or tapering of the distal end to ease insertion within the cylindrical unthreaded orifice. According to still yet another embodiment of the tool body, the threaded portion may further include opposed flats disposed adjacent to the proximal portion and parallel to the tool axis. According to this particular embodiment, the flats may be configured to receive a wrench to prevent the hollow tool body from rotating during installation of the hollow tool body within the cylindrical unthreaded orifice.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the result is not significantly changed.

From the above description of the embodiments of a tool, system, and method for applying pressure through a cylindrical unthreaded orifice, it is manifest that various alternative structures may be used for implementing features of the present invention without departing from the scope of the claims. The described embodiments are to be considered in all respects as illustrative and not restrictive. It will further be understood that the present invention may suitably comprise, consist of, or consist essentially of the component parts, method steps and limitations disclosed herein. The method and/or apparatus disclosed herein may be practiced in the absence of any element that is not specifically claimed and/or disclosed herein.

For example, tool 100 and its component dimensions may be scaled to any cylindrical unthreaded orifice 200 size. It will further be understood that any suitable tool surface treatments such as, anodizing to increase tool durability, or sand blasting or knurling could be added to the outside of the wedge sleeve 104 to further increase friction within the orifice 200. Additionally, the tube or hose 202 may be attached by other means besides barbs 154 shown in FIGS. 1, 2A-2B and 3-4, such as threaded fitting, push-to-connect, welding, etc. It will further be understood that the nut 108 and washer 106 could be combined into a single part. For low pressure applications the hex nut 108 may be replaced with a wing nut allowing the user to install the tool by hand (no wrenches needed). It will also be understood that nut 108 could be replaced with another means of applying force between the wedge sleeve 104 and tool body 102 such as cam, ratcheting tooth, external tool, etc. From an operational perspective, the tool 100 may also be used for applying vacuum instead of applying pressure.

While the foregoing advantages of the present invention are manifested in the detailed description and illustrated embodiments of the invention, a variety of changes can be made to the configuration, design, and construction of the invention to achieve those advantages. Hence, reference herein to specific details of the structure and function of the present invention is by way of example only and not by way of limitation.

What is claimed is:

1. A tool for applying pressure through a cylindrical unthreaded orifice to a system under test, comprising:
a tool body including a proximal end separated from a distal end along a tool axis and a passage extending axially from the proximal end to the distal end for delivering a pressurized fluid from a source through the cylindrical unthreaded orifice to the system under test, the tool body further comprising:
a distal portion extending from the distal end towards the proximal end, the distal portion comprising an external diameter, D₁, the distal end configured to slide within the cylindrical unthreaded orifice;
a tapered portion extending from the distal portion towards the proximal end and having variable external diameter decreasing from D₁ to D₂;
an intermediate portion extending from the tapered portion along the tool axis towards the proximal end having external diameter, D₂;
a threaded portion having external threading and extending from the intermediate portion along the tool axis towards the proximal end having an external diameter, D₃, where D₁>D₃; and
a proximal portion extending from the threaded portion along the tool axis to the proximal end;
a wedge sleeve having a hollow cylindrical shape with an external diameter, D₅, and an internal diameter greater than D₃, and configured to slide over the threaded portion;
a washer having an internal diameter also greater than D₃, but less than D₅; and
a nut configured with internal threading mating with the external threading of the threaded portion.

2. The tool according to claim 1, wherein the distal portion of the tool body further comprises an O-ring groove disposed about a circumference of the distal portion.

3. The tool according to claim 2, further comprising an O-ring configured to set within the O-ring groove and provide a seal and interference fit between the tool and the cylindrical unthreaded orifice.

4. The tool according to claim 1, wherein the distal portion of the tool body further comprises rounding or tapering of the distal end to ease insertion within the cylindrical unthreaded orifice.

5. The tool according to claim 1, wherein the threaded portion of the tool body further comprises opposed flats disposed adjacent to the proximal portion and parallel to the tool axis, the flats configured to receive a wrench to prevent the tool body from rotating during installation of the tool within the cylindrical unthreaded orifice.

6. The tool according to claim 1, wherein the wedge sleeve further comprises at least one longitudinal slot extending from a wedge sleeve distal end to a point and not completely to a wedge sleeve proximal end.

7. The tool according to claim 6, wherein the wedge sleeve further comprises an internal edge beveling on the wedge sleeve distal end configured to push against the tapered portion without gouging the tapered portion by application of axial force in a distal direction caused by tightening of the nut pushing against the washer and in turn against the wedge sleeve proximal end during installation of the tool within the cylindrical unthreaded orifice.

8. The tool according to claim 1, wherein the proximal portion further comprises a plurality of circumferential barbs disposed about an outer surface of the proximal portion configured for receiving and gripping an inner surface of a hose leading to a pressure source.

9. The tool according to claim 1, wherein the tool body and wedge sleeve each comprise a metal selected from the group consisting of: brass, bronze, copper, and metal alloys thereof.

10. A system for applying pressure through a cylindrical unthreaded orifice to a system under test including the tool recited in claim 1, further comprising a hose having a first end configured for installation on the proximal portion of the tool body.

11. The system according to claim 10 further comprising a pressure regulator configured for interfacing between a pressure source a second end of the hose.

12. The system according to claim 11, wherein the pressure source is an air compressor.

13. A hollow tool body having a tool axis, the tool body used to apply pressure through a cylindrical unthreaded orifice, the tool body comprising:
a distal portion having external diameter, D₁, extending axially from a distal end toward a proximal end and configured to slide within the cylindrical unthreaded orifice;
a tapered portion having variable diameter ranging between D₁, and D₂, extending axially from the distal portion;
an intermediate portion having external diameter, D₂, extending axially from the tapered portion;
a threaded portion having external threading with external diameter, D₃, where D₁>D₃, and extending axially from the intermediate portion; and
a proximal portion having external diameter, D₄, where D₃>D₄, and extending from the threaded portion to a proximal end.

14. The hollow tool body according to claim 13, wherein the distal portion further comprises an O-ring groove disposed about a circumference of the distal portion.

15. The hollow tool body according to claim 14, further comprising an O-ring configured to rest within the O-ring groove and provide a seal and interference fit between the hollow tool body and the cylindrical unthreaded orifice.

16. The hollow tool body according to claim 13, wherein the distal portion further comprises rounding or tapering of the distal end to ease insertion within the cylindrical unthreaded orifice.

17. The hollow tool body according to claim 13, wherein the threaded portion further comprises opposed flats disposed adjacent to the proximal portion and parallel to the tool axis, the flats configured to receive a wrench to prevent the hollow tool body from rotating during installation of the hollow tool body within the cylindrical unthreaded orifice.

18. A method of pressure testing a system under test through a cylindrical unthreaded orifice, the method comprising:
providing a system for applying pressure through the cylindrical unthreaded orifice, the system comprising:
a hollow tool having a distal portion configured for insertion and interference fit within the cylindrical unthreaded orifice;
a hose with a first end configured to attachment to a proximal portion of the tool;
a pressure source; and
a pressure regulator interfacing between a second end of the hose and the pressure source;
inserting the distal portion of the tool within the cylindrical unthreaded orifice to form a seal;
tightening the tool within the cylindrical unthreaded orifice; and
applying a preselected pressure using the pressure source through the tool and through the cylindrical unthreaded orifice to the system under test.

19. The method according to claim 18, further comprising:
reducing the pressure applied to the system under test; and
removing the tool from the cylindrical unthreaded orifice.

20. The method according to claim 18, wherein the pressure source is an air compressor.
